(19) United States
(12) Patent Application Publication
(10) Pub. No.: US 2006/0040167 A1
(43) Pub. Date: Feb. 23, 2006

(54) Components for electrochemical devices including multi-unit device arrangements

(75) Inventors: Adam P. Blake, Watertown, MA (US); Jason K. Kwa, Wellesley, MA (US); Tao T. Tao, Hopkinton, MA (US); Garrett F. Bingle, Shirley, MA (US); Reinder J. Boersma, Webster, MA (US); Jack A. Shindle, Rutland, MA (US); Wei Bai, Westborough, MA (US)

Correspondence Address: WOLF GREENFIELD & SACKS, PC;FEDERAL RESERVE PLAZA, 600 ATLANTIC AVENUE, BOSTON, MA, 02210-2211, US

(73) Assignee: CellTech Power, Inc., Westboro, MA (US)

(21) Appl. No.: 11/167,079

(22) Filed: Jun. 24, 2005

Related U.S. Application Data
(63) Continuation of application No. 10/966,455, filed on Oct. 15, 2004, now abandoned.
(60) Provisional application No. 60/511,729, filed on Oct. 16, 2003.

(51) Int. Cl. H01M 8/24; H01M 8/10

(52) U.S. Cl. 429/38; 429/31; 429/32

(57) ABSTRACT

Systems for interconnecting two or more electrochemical devices such as fuel-to-energy conversion devices are described. A unitary manifold structure can include a manifold for delivery of a reactant gas to two or more devices, and/or electrical circuitry addressing the two or more devices. Electrical circuitry can be provided in combination with conduits for delivery of reactant gases. Inter-device connecting apparatus can define boundaries for separation of at least two reactant gases addressing the devices, and a plurality of inter-device connecting apparatuses can be interconnected themselves to form larger arrangements of essentially infinite size.

### RELATED APPLICATIONS

This application is a continuation of U.S. patent application Ser. No. 10/966,455, filed Oct. 15, 2004, which claims priority under 35 U.S.C. §119(e) to U.S. Provisional Application Ser. No. 60/511,729, filed Oct. 16, 2003, entitled “Components for Electrochemical Devices Including Multi-Unit Device Arrangements” by Adam P. Blake et al., each of which is incorporated herein by reference.

### FIELD OF THE INVENTION

The present invention is directed to electrochemical devices such as fuel-to-energy conversion devices and, more particularly, to systems and components that can be used to address electrochemical devices by providing electrical connections, fuel delivery, and other functions as well as providing arrangements of multiple devices linked together in a multi-device system.

### BACKGROUND OF THE INVENTION

The conversion of fuel to energy defines technology at the center of one of the most important industries in existence. Most energy conversion in this arena involves the combustion of fuel to produce mechanical, thermal, and/or electrical energy. Coal, oil, and gasoline are fuels typically used in conventional combustion technology. The combustion of these fuels (burning) involves applying enough heat to the fuel, in the presence of an oxidant such as the oxygen in air, for the fuel to undergo a relatively spontaneous and ill-defined combustive, often explosive, reaction in which chemical bonds in the fuel break and reactions with oxygen occur to produce new compounds that are released into the environment (exhaust). In the process, energy is released in the form of heat and an expansive force, which can be used to drive a piston, turbine, or other mechanical device. This mechanical energy can be used directly, e.g., to drive an automobile or propel a jet aircraft. It also can be converted into electrical energy by linking the mechanical device to an electrical generator. Or it can simply be used to provide heat, e.g., in a home.

Fuel combustion is, as noted, relatively ill-defined. That is, the precise chemistry occurring during combustion is not well known or easily controlled. What is known is that the resulting exhaust typically includes a wide variety of toxic compounds such sulfur-containing toxins, nitrous compounds, and unburned fuel droplets or particles (soot), some of which can be converted by sunlight into other toxins such as ozone, as well as a significant amount of carbon dioxide which, while not toxic, is an important greenhouse gas that many experts believe is affecting the environment.

Cutting edge research and development in the area of energy conversion is generally aimed at improving efficiency and/or reducing the emission of toxic pollutants and greenhouse gases. Fuel cells represent a significant advance in this area. Fuel cells are generally very clean and efficient, and also are very quiet, unlike most combustion engines and turbines. Fuel cells convert fuel directly into electrical energy via a relatively well-defined, controllable, electrochemical reaction that does not involve explosive combustion. In some systems, the only reaction product exhausted into the environment is water. In electrical production, no intermediate mechanical device, such as a piston engine or turbine, is needed, thus the process is generally much more efficient, since intermediate mechanical devices cause significant energy loss through friction, etc. The efficiency of conversion of fuel to mechanical energy via combustion in a piston engine is also hampered by the laws of physics; the Carnot Cycle, via which piston engines operate, determine the limit of efficiency in the conversion of heat, from combustion, into mechanical work. Significant loss of energy is unavoidable.

While fuel cell technology has been developed to some extent, it has not assumed a significant role in worldwide energy conversion. Significant improvements are likely needed for this to happen.

### SUMMARY OF THE INVENTION

The present invention provides a series of components for electrochemical devices that can be used with single devices or can be used to link together multiple electrochemical devices for simultaneous, interrelated operation, and related techniques and methods. A variety of electrochemical devices can benefit from the invention, and although the invention is described primarily in the context of chemical or fuel-rechargeable energy conversion units, those of ordinary skill in the art will recognize that the invention applies, in essentially all instances where this terminology is used, to other electrochemical devices including, without limitation, batteries, fuel-rechargeable batteries, and mixed fuel-to-energy conversion device/battery arrangements.

In one aspect, the invention provides a series of systems for addressing electrochemical devices. One system for addressing at least two fuel-to-energy conversion devices includes a housing for an electrical conductor for electrical connection to an electrode of each of the at least two devices, and a conduit for delivery of a gas to at least one of the devices. The gas is a reductant to the electrical conductor. The conduit is in fluid communication with the housing for the electrical conductor in this embodiment.

Another system of the invention includes a plurality of interconnected fuel-to-energy conversion devices. Each device includes a reactant gas chamber into which at least a first reactant gas is delivered via a conduit that isolates the first reactant gas from all other fluids by which the device operates, and an exterior. An external environment fluidly interconnects the exterior of each device, within with each device is exposed to a second reactant gas.

Another system of the invention includes at least one fuel-to-energy conversion device comprising a plurality of separately-manufactured components that are not isolated conduits. The components are interconnected at inter-component junctions, at least one junction between non-conduit components defining a portion of an oxidant-fuel barrier.

Another system of the invention involves a fuel-to-energy conversion device including a first end and a second end. An anodic electrical lead addresses an anode of the device, and a cathodic electrical lead addresses a cathode of the device. Each of the anodic and cathodic electrical leads is routed to the first end of the device for connection to an external electrical circuit.

Another system of the invention is a fuel-to-energy conversion device system including a plurality of interconnected, interoperative devices structurally connected to each other via a structural, supporting framework that defines the structural position of each device relative to an adjacent device. The structural framework is free of any electrical connections interconnecting the devices.

Another system of the invention is a fuel-to-energy conversion device system including a plurality of interconnected, interoperative fuel-to-energy conversion devices each comprising an anode and a cathode, and a direct electrically-conductive pathway interconnecting the cathodes of at least two devices with the anodes of at least two different devices.

Another system of the invention includes an article having at least two ports for receiving at least two separate fuel-to-energy conversion devices, the article comprising means for supplying at least one reactant gas to at least two fuel-to-energy conversion devices associated with the at least two ports, and a means for providing electrical connection to at least two fuel-to-energy conversion devices associated with the at least two ports.

Another system of the invention includes an article having at least two ports for receiving at least two separate fuel-to-energy conversion devices, each of the at least two ports in fluid communication with a conduit connectable to a source of a reactant gas, and a conduit via which electrical connection can be established with a fuel to energy conversion device associated with the port.

In another aspect, the invention provides a series of methods. One method involves preventing corrosion of an electrical conductor for electrical connection to an electrode of at least two fuel-to-energy devices. The method involves exposing the electrical conductor to a gas that is a reductant to the conductor during device operation.

In another aspect the invention provides a series of devices. One device is an electrochemical device comprising an anode, a cathode, and an electrolyte. The electrolyte has an active portion across which electrochemistry occurs under device operating conditions and an inactive portion across which electrochemistry does not occur under device operating conditions. The inactive portion is constructed and arranged to structurally connect the device to a manifold constructed and arranged to separate fuel supplied to the device from oxidant supplied to the device.

Another aspect of the invention involves an electrical connection apparatus for use in a fuel-to-energy conversion device system. The apparatus includes a first set of a plurality of elongated, essentially rigid, electrically-conductive elements in fixed, essentially parallel relation to each other. The elements are constructed and arranged to electrically address a set of anodes of at least a first and a second fuel-to-energy conversion device. A second set of a plurality of elongated, essentially rigid, electrically-conductive elements in fixed, essentially parallel relation to each other, and are constructed and arranged to electrically address a set of cathodes of at least a third and a fourth fuel-to-energy conversion device. An electrical connector connects the first set of elements with the second set of elements.

The subject matter of this application may involve, in some cases, interrelated products, alternative solutions to a particular problem, and/or a plurality of different uses of a single system or article.

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF THE DRAWINGS

FIG. 1 is an illustration of a general arrangement of a chemical or fuel-rechargeable energy conversion unit which can find use in the present invention;

FIG. 2 is a cross-sectional view of a chemical or fuel-rechargeable energy conversion unit arranged generally according to the design of FIG. 1, with modification, and in greater detail;

FIG. 3 illustrates three units of the general type illustrated in FIGS. 1 and 2, interoperatively linked together via apparatus according to one embodiment of the invention, all in cross-section;

FIG. 4 is a general perspective view of the arrangement of FIG. 3;

FIG. 5 is a generalized perspective view of three systems of FIG. 4; interoperatively linked;

FIG. 6 is a top, cross-sectional view through line 6-6 of FIG. 3, where the system is modified to include five chemical or fuel-rechargeable energy conversion units with “shared” cathode current collectors linking adjacent units;

FIG. 7 is a top view of a series of eight adjacent, five-unit panels, which could be considered taken through a line 7-7 of FIG. 3, although the arrangement of FIG. 7 is significantly different from that of FIG. 3; and

FIG. 8 is a side view of a three-unit, interoperatively-linked device similar to that illustrated in FIG. 3.

### DETAILED DESCRIPTION OF THE INVENTION

The following patent applications and publications are incorporated by reference herein: International patent publication no. WO 01/80335, published Oct. 25, 2001, entitled “An Electrochemical Device and Methods for Energy Conversion”; U.S. patent publication no. 2002/0015877 A1, published Feb. 7, 2002, entitled, “A Carbon-Oxygen Fuel Cell”; international patent publication no. WO 03/001617, published Jan. 3, 2003, entitled, “Electrode Layer Arrangements in an Electrochemical Device”; international patent publication no. WO 03/044887, published May 30, 2003, entitled, “An Electrochemical System and Methods for Control Thereof”; and international patent publication no. WO03/067683, published Aug. 14, 2003, U.S. patent application No. 60/477,281, filed Jun. 10, 2003, entitled “Oxidation Facilitator”, and U.S. patent application Ser. No. 60/492,924, filed Aug. 6, 2003, entitled “Technique for Plating and Article Made Thereby.” As mentioned, a variety of electrochemical devices can benefit from the present invention. Wherever “fuel cell” is used in any of the references incorporated herein, it is to be understood that any electrochemical device, including all disclosed herein, can be substituted.

The present invention is directed to electrochemical devices, with particular use in fuel-to-energy conversion devices. A fuel-to-energy conversion device is a device that converts fuel to electrical energy electrochemically, that is, without combustion of the fuel (although a fuel-to-energy conversion devices could be used in conjunction with a device deriving energy from combustion of the same fuel). A typical fuel-to-energy conversion devices includes two electrodes, an anode and a cathode, an electrolyte in contact with both the anode and cathode, and an electrical circuit connecting the anode and the cathode from which power created by the device is drawn. In typical operation, an oxidant (e.g., oxygen, or simply air) is provided to the cathode where it is chemically reduced oxygen ion, which is delivered to the anode via the electrolyte. Fuel, such as hydrogen or a hydrocarbon, is supplied to the anode where it reacts with oxygen ion to form products including water and/or carbon dioxide, and the reaction releases electrons as the fuel is oxidized. The electrons are removed from the anode by a current collector or other component of an electrical circuit. The overall reaction is energetically favorable, i.e., the reaction gives up energy in the form of power driving electrons from the anode through electrical circuitry to the cathode. This energy can be captured for essentially any purpose.

Some embodiments of the present invention also can act as a rechargeable energy conversion unit, using fuel to produce energy which can be immediately discharged for use, can be stored for later discharge, or the like. In an energy conversion storage process, fuel can be supplied to the anode and reacted to produce electrons as the fuel is oxidized, as described above, with energy being stored in the unit. Energy can be stored in the anode, in this process, as the oxidation of fuel drives a metal/metal oxide species equilibrium within the anode toward metal (metal oxide is reduced to metal). This stored energy can be discharged by allowing this equilibrium to move toward metal oxide species (with metal or metal oxide reacting with oxygen ion, described above, to generate metal oxide or a more oxidized metal oxide species, respectively), driving electric current from the anode via a current collector or other component of an electrical circuit. In this arrangement, fuel-to-energy conversion can result in energy, all of which (with the exception of that lost to thermodynamic inefficiency) can be stored in the device, all of which can be discharged for use simultaneous with conversion, or the device can operate with the level of energy conversion during fuel consumption at a level varying independently with the amount of energy discharged by the device. For example, where more energy can be converted from fuel in the device than is discharged by the device, storage can occur, and where more discharge by the device is required than the amount of energy that can be converted from fuel, the energy mismatch can be made up by drawing upon stored energy within the device. Any or all of these processes can happen simultaneously or independently of each other.

The present invention provides, generally, structures and arrangements for linking a plurality of electrochemical devices such that they can operate together, and related methods and techniques. Although the invention relates generally to multi-unit arrangements, individual components or techniques provided by the invention that can find use with single devices can be used with single devices, and need not be used only in multi-device arrangements.

Individual aspects of the overall electrochemistry involved in electrochemical devices such as those described herein is generally known, and will not be described in detail herein. The reader can refer to the above-described patent applications and publications incorporated herein by reference for a detailed description of some of the specific electrochemistry involved in some of the devices that can find use in connection with the present invention.

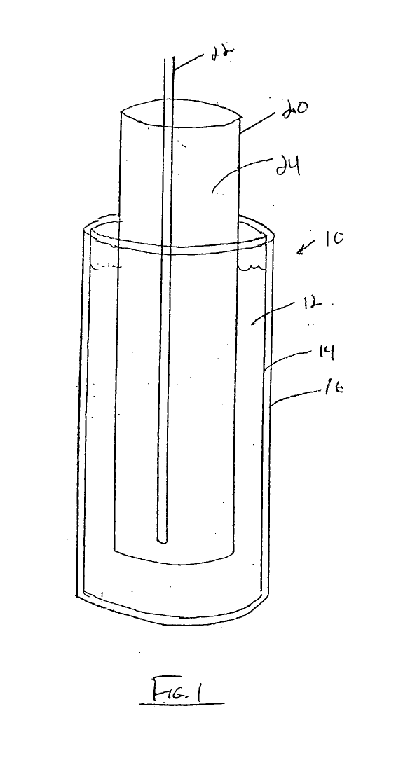

Referring now to FIG. 1, a schematic illustration of one general geometric arrangement of an electrochemical device, which can benefit from components, connections, and techniques of the present invention is illustrated, specifically, a chemical or fuel-rechargeable energy conversion unit. As used herein, a “chemical or fuel-rechargeable energy conversion unit” is a unit which has the ability to electrochemically convert a fuel (a chemical) to energy, and to store at least a portion of that energy for later discharge. In one embodiment, the unit can convert fuel to energy and store essentially all of that energy (all of the energy not lost to thermodynamic inefficiencies), for later discharge. In another embodiment, some of the converted energy is discharged (used to provide power to a home, auto, business, etc.) essentially immediately upon conversion, while some is stored for discharge later, e.g. when fuel is not available and/or when power demands exceed the ability of the device to convert fuel to energy.

In FIG. 1, electrochemical device 10 is arranged in a substantially cylindrical configuration including an outer, cylindrical cathode 16, a cylindrical electrolyte 14 inside and in contact with cathode 16, a liquid anode 12 contained by electrolyte 14, a cylindrical oxidation facilitator 20 immersed within a portion of anode 12, thereby defining at least one compartment within which anode 12 is contained, and a fluid delivery conduit 22 positioned to deliver fuel to oxidation facilitator 20. As illustrated, fuel delivery conduit introduces fuel into a cylindrical container defined by oxidation facilitator 20.

It is to be understood that specific electrochemical devices described herein are exemplary only, and the components, connections, and techniques of the present invention can be applied to virtually any suitable electrochemical device including those with a variety of liquid or gaseous fuels, and a variety of anodes, cathodes, and electrolytes, all of which can be liquid or solid under operating conditions (where feasible; generally, for adjacent components one will be solid and one will be liquid if any are liquids).

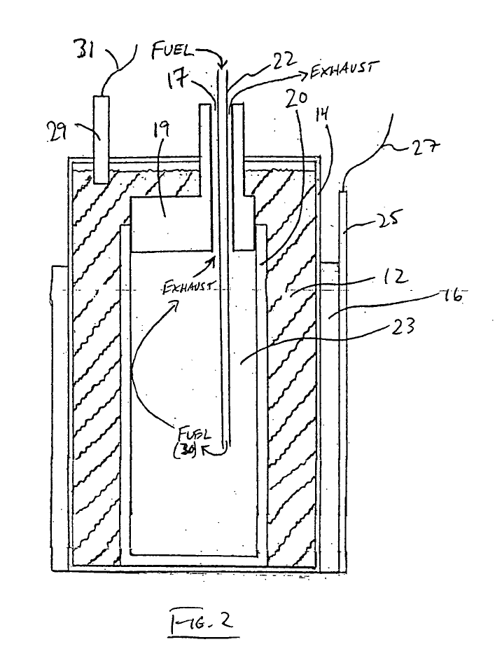

Referring now to FIG. 2, the generalized arrangement of FIG. 1 is illustrated in cross-section, in greater detail. The difference in perspective (component size) between FIGS. 1 and 2 is representative of the variety of configurations and arrangements possible. In FIG. 2 oxidation facilitator 20 is of a substantially cylindrical shape with a closed bottom and an open top, although as would be readily understood, the bottom can be formed of any material and/or the facilitator can be positioned such that the bottom has access to the anode, as shown in FIG. 1.

In the embodiment illustrated, oxygen facilitator 20 is inside of and rests on the bottom of substantially cylindrical electrolyte 14, and cylindrical electrolyte 14 has a closed top and bottom, which may be made of the same or different material as the electrolyte material.

The open top of cylindrical oxidation facilitator 20 is substantially completely sealed by a plug 19 which includes an opening 17 therein, allowing communication between the interior of a cylindrical compartment formed by facilitator 20 and the environment external to the device. Fuel delivery conduit 22 passes through opening 17 and extends into the cylindrical compartment defined by facilitator 20, which can thereby define a fuel manifold or reaction chamber. Fuel conduit 22 does not completely block opening 17, but allows for escape of exhaust through space 17 defined between the exterior of fuel conduit 22 and the interior of the passage of plug 19 when conduit 22 is present. Fuel conduit 20 can be positioned (e.g. centered) within passage 17 by essentially any routine technique. Passage 17 thus defines an exhaust passage which can be connected to an exhaust conduit, described more fully below.

Facilitator 20 and plug 19 can be made to define a fluid-tight (other than passage 17) device which, positioned within a space defined by the interior of electrolyte 14, does not completely fill the space, and at least a portion of plug 19 extends outside of (above, as illustrated) the space. The remainder of the space can be filled with an anode 12 (optionally liquid) which is contained by electrolyte 14 and which is not allowed to flow into the compartment defined within facilitator 20. Stated another way, the combination of facilitator 20 and plug 19 is placed within a compartment defined by electrolyte 14, and some or all of the remaining space within the compartment is filled with liquid anode 12. In the embodiment illustrated, facilitator 20 in part defines a compartment constructed and arranged to contain an anode that is a fluid during operation of the unit, and also defines, in part, the fuel manifold. The anode physically contacts electrolyte 14 and facilitator 20. In one embodiment, the facilitator is constructed and arranged to be integrated with other components so that it is between the fuel and the anode, and may prevent flow between the fuel and anode where one or both is a fluid, but also may allow fuel and anode to come into contact with each other at one or more locations where oxidation occurs.

These embodiments can be provided in combination, i.e., a fuel oxidation facilitator can include portions across which oxidation occurs where fuel and anode are completely separate, and other portions across which oxidation occurs where fuel is allowed to contact anode. As used herein, “flow” means bulk movement of one species into another species or compartment, e.g., where a liquid anode and gaseous fuel are prevented from flowing into each other or into each other's compartment, the gaseous fuel does not bubble into the liquid anode, and the liquid anode does not flow into the fuel. The meaning of “flow” herein does not, however, exclude diffusion. E.g., gaseous fuel may diffuse into a liquid anode, i.e., fuel molecules can become dissolved or dispersed within the liquid anode, although there may be no bulk amount of gaseous fuel within the anode (bubbles). In another embodiment, gaseous fuel may be allowed to actually flow through the facilitator and bubble into the anode, but anode is prevented from flowing into the fuel manifold.

In the embodiment illustrated, cathode 16 is arranged cylindrically to surround electrolyte 14, and is in contact with a cathode current collector 25, addressed by an electrical lead 27 communicating with an electrical circuit (described below). An anode current collector 29 is in electrical contact with (e.g. submerged within) anode 12, and is addressed by an electrical lead 31 which communicates with the electrical circuit.

In typical use an oxidant, such as air, is allowed to contact cathode 16. Electrons delivered from an external circuit, described more fully below, reduce the oxidant at cathode 16 and deliver the reduced oxidant across electrolyte 14 to anode 12. In one embodiment, anode 12 is a liquid anode comprising a metal and various oxidation products of the metal. In such an arrangement, reduced oxidant delivered by the electrolyte can oxidize anode metal atoms to form an oxidation product (which can be one of a variety of oxidation products including metal oxide, in various stoichiometries, optionally with other species). Metal oxide within anode 12 can deliver an oxidizing species (such as a metal oxide species) across oxidation facilitator 20 to oxidize a fuel 30, which reaction delivers electrons from within or across oxidation facilitator 20 to anode 12 for delivery to the external circuit. Fuel is delivered from a source that is not shown. In some arrangements, exhaust can simply diffuse into air, but in most arrangements exhaust will be collected in an exhaust conduit, described below, and treated in an environmentally sound manner. The exhaust typically will contain only water and unspent fuel (which can be re-used), or water, unspent fuel, and carbon dioxide.

It is to be understood that the chemical or fuel-rechargeable energy conversion unit arrangement of FIGS. 1 and 2 is but one example of one electrochemical device that can make use of systems and techniques of the present invention as recited in the claims of this document. Many structural arrangements other than those disclosed herein, which make use of and are enabled by the present invention, will be apparent to those of ordinary skill in the art, and some are disclosed herein. For example, many other arrangements for forming manifold 23, delivering fuel to the manifold, and removing exhaust from the manifold are possible other than the arrangement including plug 19, conduit 22, passage 17. For example, oxidation facilitator 20 could form an enclosed chamber by itself permeated only by a delivery conduit 22, and a separate exhaust conduit near conduit 22 or at the other end of the chamber relative to conduit 22.

A variety of modifications can be made to the arrangement of FIG. 2 to increase or decrease thickness of any component and/or change the relative surface area of contact between any two components in comparison to the surface area of contact between any other two components. For example, the “thickness” of anode 12 can be varied simply by varying the external diameter of oxidation facilitator 20 and/or the internal diameter of electrolyte 14. As an example of relative surface area variation, the surface area of facilitator 20 exposable to anode 12 can be decreased, relative to the surface area of electrolyte 14 exposed to anode 12, by decreasing the height of facilitator 20 and/or decreasing its radius. The same can be increased by decreasing the fluid level of anode 12 within the container defined by electrolyte 14, or by reversing the relative positions of facilitator 20 and electrolyte 14. In the latter arrangement, facilitator 20 defines a cylindrical compartment within which electrolyte 14 resides, the space between the two filled (or partially filled) by anode 12. In this arrangement, oxidant is delivered within electrolyte 14 (similar to the delivery of fuel as shown in FIG. 2) and fuel is delivered to the exterior of facilitator 20 by a manifold arrangement easily constructible by those of ordinary skill in the art (or the entire arrangement can be placed with in a fuel environment). Cathode 16 would be placed within electrolyte 14 in the “reversed” arrangement.

The ability to vary the thickness of the elements of an electrochemical device according to the invention and/or adjust the relative areas of surface contact between components can impact the efficiency of the device. For example, portions of the system which are of relatively low conductivity, or are otherwise rate limiting, may be decreased in thickness. Similarly, it may be possible to reduce the amount of higher cost materials used. In particular, embodiments of the present invention allow a liquid anode to be contained by an oxidation facilitator, in turn allowing the anode to be kept relatively thin (e.g., significantly, proportionately thinner than as illustrated in FIG. 2). Reduction in anode thickness can reduce the resistance of the electrochemical device, and reduces the amount of anode material required, improving efficiency and reducing cost and weight.

The invention allows for modification of design that can be used to affect device power, battery storage capacity, or both. For example, by increasing surface area of contact between the oxidation facilitator and the fuel and anode, continuous power output is improved. By increasing the amount of anode present, battery storage is increased, in embodiments where a rechargeable anode is used. Each of these can be controlled, independently of each other, e.g. by changing the radius of the oxidation facilitator (where cylindrical), or designing the oxidation facilitator in other ways to geometrically create more surface area (e.g. with a wavy, jagged, and/or porous facilitator), and/or by increasing or decreasing the thickness of the anode, as discussed above. These changes can be useful when designing different fuel-to-energy conversion devices for different uses requiring more or less power and/or more or less battery storage capacity, e.g., for home power use, commercial or industrial use, automobile use, different climates, etc.

Oxidation facilitation device 20 can be any structure or material that can place the anode and fuel in oxidative communication, i.e., an arrangement in which the anode can facilitate oxidation of the fuel. Purposes served by the oxidation facilitator can include improving fuel efficiency, maximizing surface area between fuel and anode at which oxidation can occur (whether fuel and anode are allowed to physically contact each other or not), defining a portion of a fuel compartment (manifold), defining a portion of an anode compartment, and/or other functions. The oxidation facilitator can operate to allow connection between fuel and anode ionically, physically, or both. The facilitator can be semi or fully porous. That is, the facilitator can include pores allowing contact directly between fuel and anode but not bulk flow of anode into the fuel. Alternatively, the oxidation facilitator can facilitate the passage of an oxidant such as oxygen across the facilitator, and also be conductive of electrons. Oxidation facilitators are described in more detail in U.S. application Ser. No. 60/477,281, referenced above, and exemplary materials are described below. The oxidation facilitator is any article that can be positioned, relative to fuel and anode, such that the anode and fuel are able to communicate chemically and/or electrochemically across the facilitator, facilitating oxidation of the fuel. The oxidation facilitator may be selected to be ionically conductive, and able to transfer oxygen ions across it between anode and fuel, at a location where anode and fuel are not in contact physically with each other (for example, in an arrangement where the anode and fuel are completely separated from each other throughout the device). Where the oxygen facilitator is ionically conductive, a return electronic path can be provided, either internally of the device (where the device is a mixed ion/electron conductor) or externally, e.g., through a separate circuit or arrangement of materials. The oxidation facilitator also can operate by a different mechanism, separately of in addition to the above mechanism, for example, by physically introducing the fuel to the anode, etc.

Where a metal anode is used, the anode can be an alloy of different metals. In such an arrangement, metal atoms in the anode cycle between two or more oxidation states including metal and various species of metal oxide. The overall reaction described is energetically favorable, thus power can be drawn from an electrical circuit connecting the anode with the cathode.

Electrochemical devices of the present invention may take the form of any kind of electrochemical device including fuel cells, batteries, fuel-to-energy conversion devices such as chemical or fuel-rechargeable energy conversion units, and essentially any similar devices such as those disclosed in international patent publication no. WO 01/80335, referenced above. As described above, electrochemical devices according to the present invention may also have a wide variety of geometries including cylindrical, planar and other configurations. An electrochemical device according to the present invention may be combined with additional electrochemical devices to form a larger device or system. In some embodiments this may take the form of a stack of unites or devices. Where more than one electrochemical device is combined, the devices may all be devices according to the present invention, or one or more devices according to the present invention may be combined with other electrochemical devices, such as conventional solid oxide fuel cells. Fuel-to-energy conversion devices are provided as one example of electrochemical devices which can be linked in accordance with the invention. It is to be understood that where this terminology is used, any suitable electrochemical device, which those of ordinary skill in the art would recognize could function in accordance with the systems and techniques of the present invention, can be substituted.

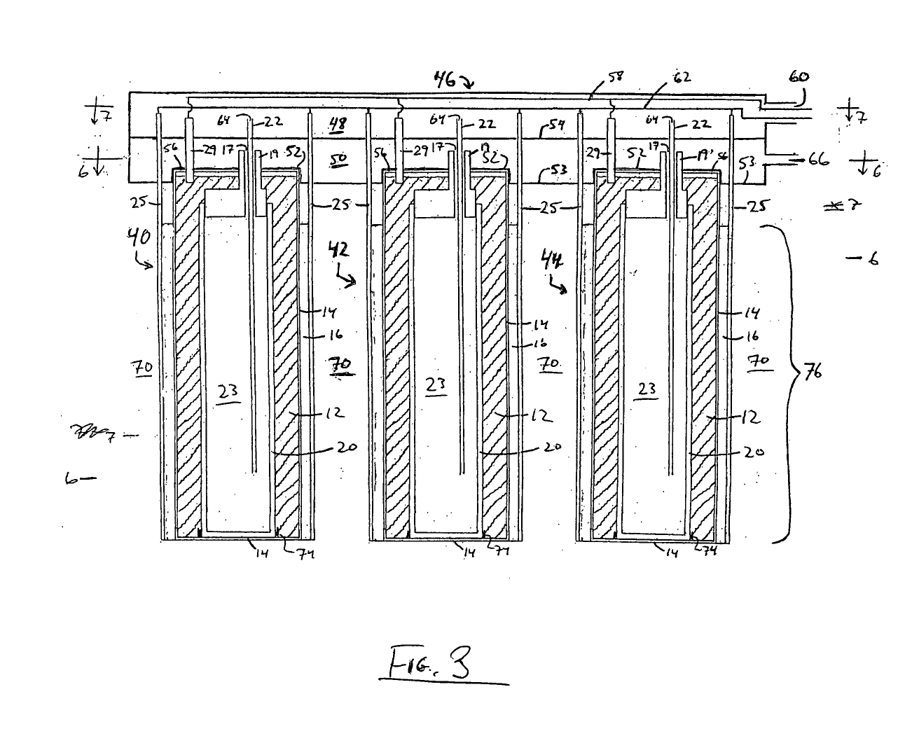

Reference will now be mad to FIG. 3. At the outset, it is noted that FIGS. 3, 6 and 7 illustrate interconnected chemical or fuel-rechargeable energy conversion units including, in some cases, a different number of units per interconnected device, devices including units of different scale and/or units of different size. This is representative of the fact that the systems and techniques of the present invention are applicable to a wide variety of electrochemical devices, linkage of different numbers of electrochemical devices, etc. Referring now to FIG. 3, a plurality of fuel-to-energy conversion devices, specifically, chemical or fuel-rechargeable energy conversion units 40, 42, and 44 form part of an interconnected system of the invention. Each of units 40-44 is essentially as described above with respect to FIG. 2, and is linked to an interconnecting electric and/or fuel management system 46 (a “unitary manifold structure”). System 46 can comprise essentially any structural arrangement or interconnected system of components that serves the function of either providing electrical connection to a plurality of chemical or fuel-rechargeable energy conversion units, or a manifold for providing fuel to a plurality of units or removing anode exhaustive gas, or any combination of these. As illustrated in the following figures and described below, system 46 can be embodied in a “panel” which interconnects a plurality of units, optionally linked to other, similar panels to form a “stack” of panels. In FIG. 3, a single, three-unit panel is illustrated schematically. It is to be understood that an interconnecting system or panel of the invention can be constructed and arranged to address any number of units including two units, three, four, five, six, seven, or more units.

In the embodiment illustrated in FIG. 3, interconnecting system 46 includes a first enclosed region 48 and a second enclosed region 50 that is isolated from region 48. That is, gas is not free to pass from region 48 into region 50 or vice versa. In the embodiment illustrated, each of regions 48 and 50 is an elongated, substantially horizontal (in use) void, with region 48 positioned above region 50. The bottom wall 53 of region 50 includes a plurality of indentations 52 shaped to receive the top end of units 40-44 and to securely support system 46 in fixed relation to the units.

Emerging from each of units 40-44, at the top end each thereof, and passing into system 46, are cathode current collectors 25, anode current collectors 29, fuel delivery conduit 22, and an upwardly-protruding, cylindrical portion of plug 19 which surrounds the outer perimeter of fuel delivery conduit 22 and is spaced therefrom to define exhaust passage 17. Each of the current collectors 25 and 29 and fuel delivery conduits 22 pass completely through region 50 and extend upwardly into region 48 of multi-unit interconnecting system 46. The upward extension of plug 19, however, extends only into region 50. Each of the current collectors 25, 29, and fuel delivery conduits 22 are in fixed relation to wall 54, separating region 48 from region 50. That is, each of the current collectors and fuel delivery conduits is in gas-tight, sealed relationship to the opening within 54 through which it passes. Current collectors 25 and 29 similarly are in sealingly-engaged relationship with openings within the bottom wall 53 through which they pass. (The upwardly-protruding portion of plug 19 passing through the bottom wall of chamber 50 is not in fixed relationship with that wall, as described more fully below.) As mentioned, the top portions of each of units 40-44 fitting within indentations 52 of system 46 are in fixed relationship to those indentations. Current collectors 29 are in fixed relationship to a top wall 56 of each of units 40-44 (the top wall can comprise an extension of electrolyte 14 in each case). The upwardly-protruding portion of each plug 19 is not in fixed relationship with wall 56. Each of the sealed, fixed boundaries between current collectors and fuel delivery conduits with walls of system 46 or top wall 56 of units 40-44 can be made via friction fit, adhesive, sintering, or the like.

The top end of each of anode current collectors 29, extending into upper region 48 of system 46, is addressed by an electrical lead forming part of an electrical connector array 58 which passes into region 50 via an opening 60 defined within upper region 48 of system 46. Similarly, each of cathode current collectors 25, at a top end thereof extending within region 48, is addressed by an electrical lead forming part of an electrical connector array 62 which also passes into region 48 via opening 60. Opening 60 also serves as a fuel conduit through which gaseous fuel is delivered into region 48. Region 48 therefore defines a fuel manifold in fluid communication with the individual fuel manifolds of each of units 40-44. Fuel within region 48 is driven through upper opening 64 of each of the fuel delivery conduits 22, passing into manifold 23 of each unit (as described above with respect to FIG. 2). Exhaust from each unit exits opening 17 into region 50 of system 46, which defines an exhaust manifold, and exits opening 66 from region 50.

It is a feature of the embodiment illustrated in FIG. 3 that region 48 of system 46 serves both as a housing for an electrical conductor for electrical connection to one or more electrodes of at least one of the fuel-to-energy conversion devices (via a current collector), and a conduit for delivery of a gas to the device, which gas can be selected to be a reductant to the electrical conductor. Typical fuels used in such devices can be selected to be reductive to electrical conductors. Typically, anode exhaustive gases also contain some unreacted fuel, and are reductive to such conductors. For example, hydrogen as a fuel is a reductant to typical electrical connector arrays 58 and 62 formed of, e.g., copper. Thus, region 48 can serve as an electrical conductor housing and conduit for delivery of gaseous fuel to the device, which fuel is a reductant relative to the electrical network. Alternatively, or in addition, electrical connector array 58 and/or 62 could pass through region 50, especially where a gas that is a reductant to the electrical leads is used but is not fully spent in driving electrochemistry within each of units 40-44, thus producing an exhaust stream exiting opening 17 (and bathing region 50) which remains reductive.

This arrangement (electrical leads addressing current collectors within isolated regions bathed in reductive gas) prevents corrosion of electrical leads that otherwise may be susceptible to oxidation, such as copper, copper alloys, nickel, nickel alloys, and other metals and/or alloys which can be used in arrangements such as these.

It can be seen that, in the embodiment illustrated in FIG. 3, interconnecting system 46 serves not only to structurally support each of units 40-44 in fixed relationship to each other, but serves as a unitary manifold structure for delivery of fuel and removal of exhaust, and optionally also serves to support and route electrical connections to the units. In this arrangement, all electrical leads within the manifold structure, up to the point that each addresses a current collector, are contained within a portion of the manifold structure bathed with a reductant gas such as fuel, during normal device operation.

Operation of each of units 40-44 will be understood from the description above with respect to FIGS. 1 and 2. Region 70, which surrounds and fluidly interconnects the exterior of each of fuel units 40-44 (to the extent that the devices and components thereof do not extend into system 46), defines a region within which an oxidant, such as oxygen or air, can be supplied to each of the devices. It can thus be seen that unit interconnecting system 46 defines a unitary manifold structure which can isolate each of fuel for the unit, exhaust produced by the unit, and oxidant for the unit from each other during operation. Viewed another way, the arrangement of FIG. 3 defines a plurality of interconnected electrochemical devices each including a reactant gas chamber 23 into which a first reactant gas (fuel, such as hydrogen) is delivered via a conduit 48 that isolates the first reactant gas from all other fluids by which the device operates, and an exterior. An external environment 70 fluidly interconnects the exterior of each unit, within which each unit is exposed to a second reactant gas (e.g., an oxidant, such as air).

In one embodiment, each of the units is “inside out reversed”. That is, in place of cathodes 16, anodes exist, and in place of anodes 12, cathodes exist. In such an arrangement, the first reactant delivered via conduit 48 is not a fuel but is an oxidant (e.g., air), and the second reactant within external environment 70 is a fuel, such as hydrogen.

The arrangement of FIG. 3 is one example of a system in which electrical leads in a device are routed to one end, selectively, of the device. As illustrated, each of units 40-44 is a fuel-to-energy conversion devices having a top (first) end and a bottom (second) end, an anodic electrical lead addressing an anode of the device, and a cathodic electrical lead addressing a cathode of the device. Each of the anodic and cathodic electrical leads is routed to the first (top) end of the device for connection to an external electrical circuit. In the embodiment illustrated, each fuel-to-energy conversion device is elongated such that a longest dimension of each device is defined between the first end and the second end. Routing electrical leads selectively to one end of the device can simplify electrical interconnection between devices. Where it is desirable to bathe all electrical connectors addressing current collectors in a reductant gas, this can be simplified in an arrangement where all electrical leads are routed to one end of the device, where all electrical leads can be easily contained within a single conduit or manifold. That is, each of the electrical leads is in fluid communication with one, but not the other, of the first reactant gas and second reactant gas, described above, within manifold 48 and external environment 70, respectively.

The arrangement of FIG. 3 embodies of yet another aspect of the invention, namely, good structural interconnection without compromising electrical connection. In the interconnection of components of individual electrochemical devices, and/or in the interconnection of a plurality of devices to each other, a typical problem can involve thermal mismatch, that is, differences in coefficients of thermal expansion between adjacent materials leading to changes in the physical relationship between those two materials upon a change in temperature. In one embodiment of the invention, adjacent components (e.g., material of portions of units 40-44 adjacent material of system 46) are made of material selected to be of the same or similar coefficient of thermal expansion. However, this is not always the case. One problematic example can involve compromised electrical connections resulting from thermal mismatch between adjacent materials across which electrical current is designed to flow during normal device operation. In the arrangement of FIG. 3, the electrochemical device system includes a plurality of interconnected, interoperative fuel-to-energy conversion devices 40, 42, and 44 structurally connected to each other via a structural, supporting framework (system 46) that defines the structural position of each device relative to an adjacent device. The structural framework, however, is free of any electrical connections interconnecting the devices. “Structural framework” in this context, means those portions of system 46 (walls 53 and 54) that structurally engage and support devices 40-44 and/or components thereof. All electrical connections interconnecting the devices are made via electrical connector arrays 58 and 62 which pass within, but are free of any structural interconnection with, conduit 48. That is, electrical arrays 58 and 62, which embody the sole electrical connection pathways between the devices, “float” relative to all of the current collectors, cathodes, anodes, electrolytes, and internal reactant manifolds within each of the devices, and relative to the different devices themselves thus any thermal expansion or contraction experienced by any of the devices or any components thereof in no way affects or compromises electrical connection to and between the devices.

Thermal expansion and contraction within each of the devices is also managed via an internal reactant gas manifold 23, defined by components which “float” relative to other components of the device. In the embodiment illustrated, oxidation facilitator 20 rests upon the bottom wall of the device defined by electrolyte 14, but is not fastened thereto. Instead, the cylindrical container defined by oxidation facilitator 20 is centered within the device by a retaining ring 74 which protrudes slightly upwardly from the bottom wall of the device, surrounding and enclosing the bottommost portion of the container defined by facilitator 20. Retaining ring 74 can, but need not, snugly engage container 20. Some “play” can exist between container 20 and retaining ring 74 to allow for thermal mismatch. At the topmost end of the container enclosing internal manifold 23, the upwardly-protruding cylindrical of plug 19 which passes through top wall 56 of the device and bottom wall 53 of exhaust manifold 50 does not sealingly or fixedly engage top wall 56 or bottom wall 52 but, instead, “floats” relative thereto. Thus, anode 12 is contained within a container defined by two walls, one of which is not affixed to the other and can move relative thereto to allow for differences in temperature within different regions of the device and/or differences in thermal expansion or contraction of different portions; internal fuel manifold 23 defined by container/oxidation facilitator 20 and plug 19 is not rigidly fixed to any other component of the device. In another arrangement, components defining the reactant gas manifold 23 do not float relative to other components of the device, but a seal is formed between plug 19 and the exhaust manifold (wall 53). This can help prevent gases within the anode compartment from leaking into the exhaust manifold. If a seal is formed between plug 19 and the exhaust manifold (wall 53), then to vent gasses within the anode compartment, the device could be arranged such that the anode level does not extend above the top of the oxidation facilitator, i.e., a void space in the anode compartment is in contact with the oxidation facilitator opposite region 23. It can be seen that each of devices 40-44 includes an electrolyte 14 having an “active portion”, across which electrochemistry occurs under operating conditions and an “inactive portion” across which electrochemistry does not occur under operating conditions. The active portion is approximately designated by bracket 76, representing the extent that cathode 16 borders electrolyte 14. Electrolyte 14, in this region 76, is bounded on one side by anode 12 and the other side by cathode 16.

Above this region 76 is the inactive portion of the electrolyte. In the embodiment illustrated, the inactive portion is constructed and arranged to structurally connect the device to interconnecting system 46.

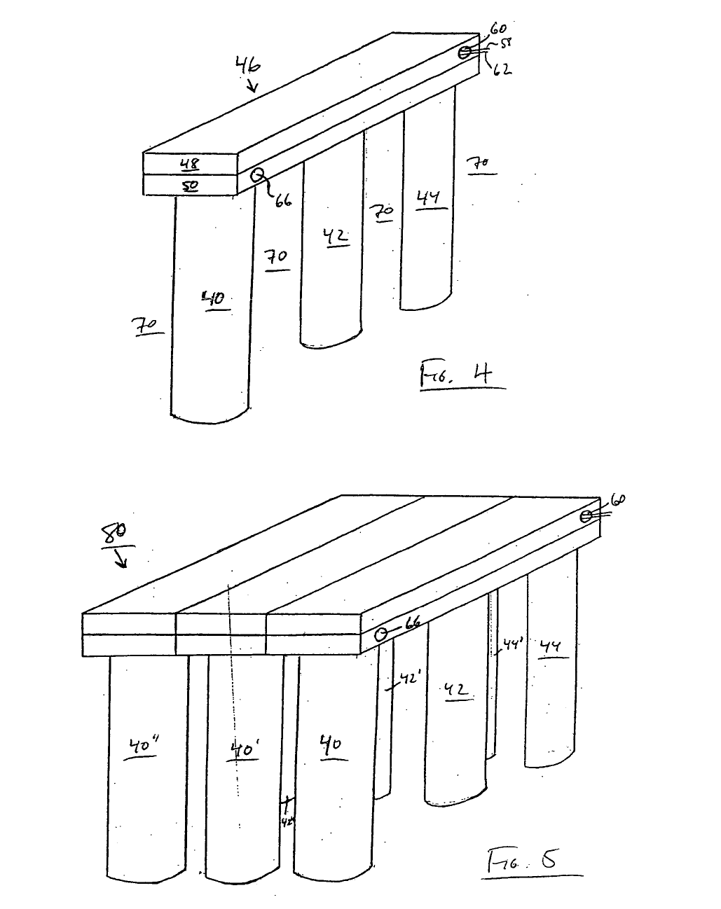

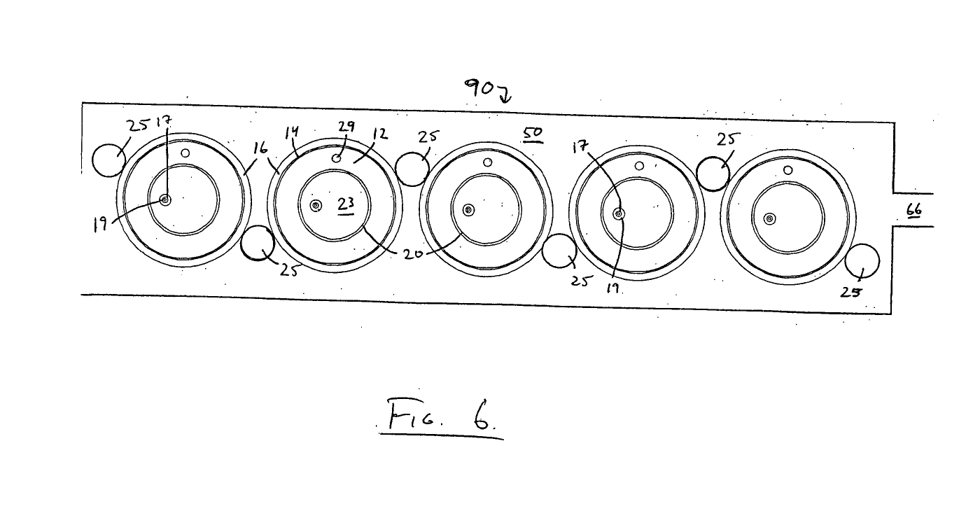

Referring now to FIGS. 4 and 5, an arrangement similar to that of FIG. 3 is shown in perspective view. The arrangement of FIG. 4 differs from that of FIG. 3, at least, in that fuel inlet 60 (through which electrical connector array leads 58 and 62 pass) and exhaust outlet 66 are oriented differently, with respect to system 46, than as illustrated in FIG. 3. In FIG. 4, conduits 60 and 62 are arranged to interconnect with another, similar “panel” (as illustrated in FIG. 4) to form a “stack” 80 in FIG. 5. Stack 80 includes a plurality of panels 46, each including a fuel conduit 60 and exhaust conduit 66 fluidly communicating with fuel and exhaust manifolds, respectively, in an adjacent panel. As connected, fuel conduit 60 of panel 46 (FIG. 4) sealingly engages a fuel conduit (not shown) of an adjacent panel and exhaust conduit 66 sealingly engages an exhaust conduit (not shown) of the same, adjacent panel. Alternatively, the fuel and exhaust conduits can be connected to non-identical, adjacent panels. In this arrangement, manifolds are connected to manifolds joining panels into stacks without the need for excess, isolated conduits. That is, stack 80 of FIG. 5 defines a system of electrochemical devices including at least one, and generally a plurality of devices (which, like other devices herein, can be fuel-to-energy conversion devices such as chemical or fuel-rechargeable energy conversion units), where the system comprises a plurality of separately-manufactured components (stacks 46) that are not isolated conduits, interconnected at inter-component junctions (where, e.g., fuel conduit 60 sealingly engages a fuel conduit on an adjacent panel or manifold), where at least one junction between non-isolated conduit components defines a portion of an oxidant-fuel barrier. The junction of fuel conduit 60 with its counterpart on an adjacent panel defines an oxidant-fuel barrier in that fuel is contained within manifold 48 and oxidant surrounds devices 40-44 in regions 70, or vice versa. An “isolated conduit”, of which the immediately-preceding junctions are not, is meant herein to define a generally elongated, typically tubular structure having an interior connecting a first end thereof to a second end thereof and a surrounding exterior, whose purpose it is to conduct fluid from the first end to the second end. An example of an isolated conduit is fuel delivery conduit 22 described above with respect to FIGS. 1-3. The junction sealingly engaging fuel passage 60 with its counterpart on an adjacent panel, or exhaust passage 66 with its counterpart, can include an adhesive joining the two together. Alternatively, or in addition, an isolated conduit can be used to connect some fuel passages to other fuel passages, or some exhaust conduits to other exhaust conduits. In the context of this discussion, “fuel” can be replaced by oxidant in the “reversed” arrangement described above.

Electrical leads passing through fuel passage 60 can be connected to an external circuit, as would be understood readily by those of ordinary skill in the art. As described above, leads 58 and 62 can be made of a metal or alloy such as copper. Of course, where the leads come in close contact with each other, they should be maintained physically separate and electrically isolated from each other.

In operation, a panel 46, including 2, 3, 4, 5, 6, 7, 8, 9, 10, or any number of individual devices, and/or a stack 80 including 2, 3, 4, 5, 6, 7, 8, 9, or any number of panels 46 as described, can be placed within a heating unit, or oven, within which oxidant is introduced (or fuel in the “reversed” arrangement) to bathe the exterior of the devices. The heating unit is desirably set at a predetermined temperature for optimal device operation. The temperature can be selected to promote the most efficient device operation, to bring any components into liquid form that are designed to be in liquid form during device operation, or the like. A heating unit or oven can readily be constructed by those of ordinary skill in the art, for the purposes and arrangements described herein. Specific heating units are not described or shown.

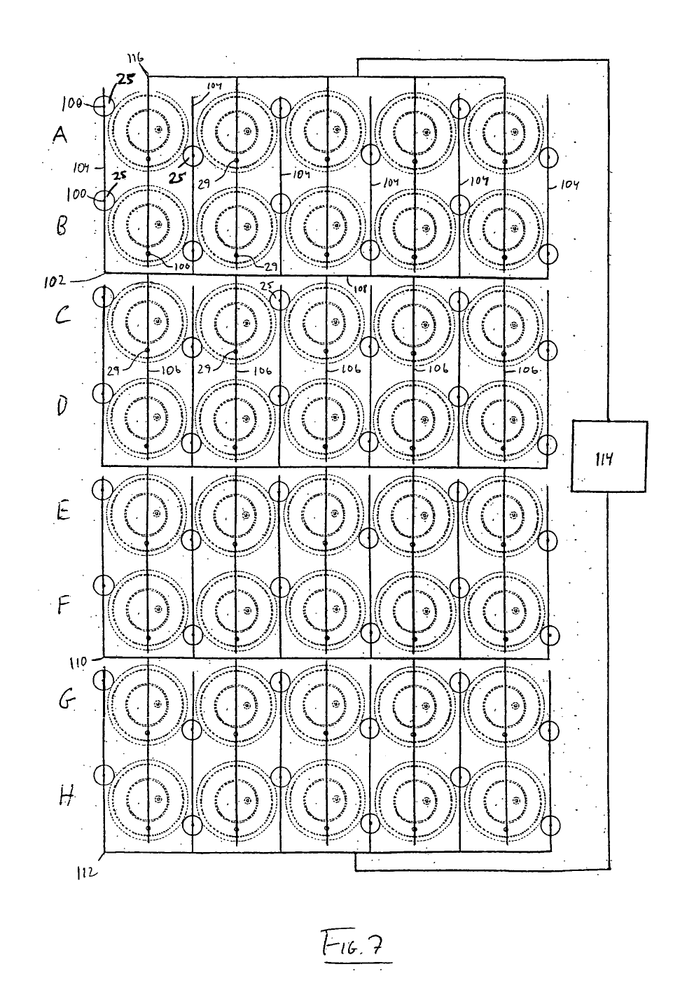

Referring now to FIG. 6, a cross-sectional view through line 6-6 of FIG. 3 (with modification) is illustrated. Modifications between the interconnecting electric and/or fuel management system (panel) 90 of FIG. 6 and the panel 46 of FIG. 3 include the fact that panel 90 is a 5-device panel, and each device is addressed by a cathode current collector 25 which simultaneously addresses at least two, adjacent devices. In the arrangement illustrated, the cathodes of each device are not contacting each other, but each cathode is contacted by a cathode current collector positioned partially between two devices. In another arrangement (not shown) the devices can be placed immediately adjacent each other with the cathode of each device contacting the cathode of an adjacent device.

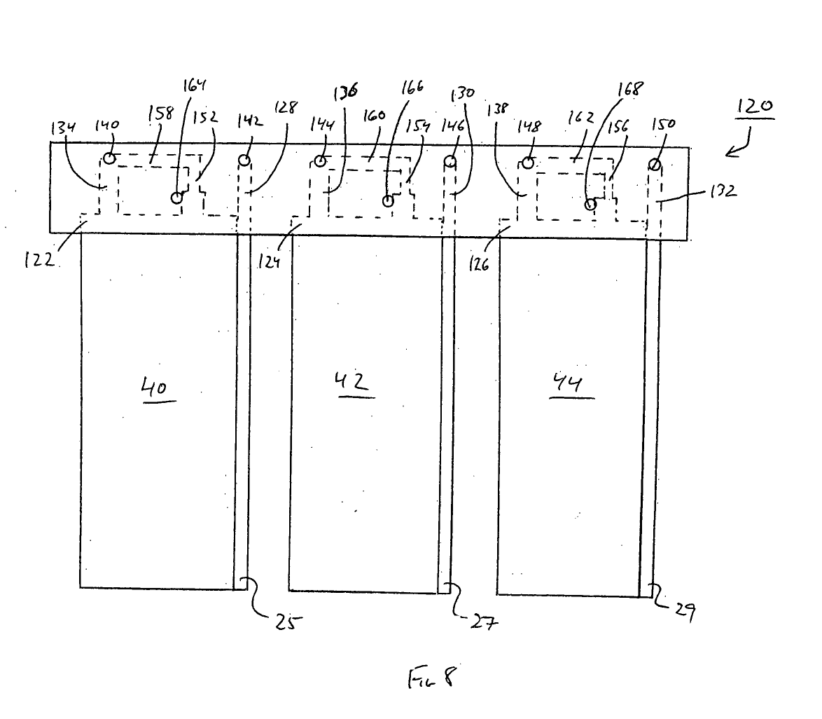

Referring now to FIG. 7, an arrangement for electrically interconnecting a plurality of electrochemical devices is illustrated. FIG. 7 is a top view of a series of adjacent, 5-device panels A-H. For purposes of clarity, none of the panels themselves are shown. However, with reference to the arrangement of panels relative to the devices of FIG. 7, FIG. 7 would be taken through a line, with reference to FIG. 3, passing through fuel manifold 48 at the level of the vicinity of the top of each current collector (although it will be recognized that the electrical interconnection arrangement of FIG. 3 is significantly different than that of FIG. 7). All components except for current collectors and current collector electrical leads, which would be hidden, are shown in dotted line. Each of panels A-H is arranged generally as shown in FIG. 6.

In the arrangement illustrated, each of cathode current collectors 25 and anode current collectors 29 can include a post 100 designed for linkage to electrical circuitry. The arrangement of FIG. 7 includes a plurality of electrical connection units 102, each of which links a plurality of cathodes of one set of devices to a plurality of anodes of a different set of devices. As illustrated, each unit 102 includes a first set of a plurality of elongated, essentially rigid, electrically-conductive elements 104 in fixed, essentially parallel relation to each other, constructed and arranged to electrically address a set of cathodes of two adjacent panels of devices via connection to posts 100 of cathode current collectors 25, and a second set of a plurality of elongated, essentially rigid, electrically-conductive elements 106, constructed and arranged to electrically address a set of anodes of two, different sets of panels of devices another set of devices, and an electrical connector 108 connecting the first set of elements 104 with the second set of elements 106. In the arrangement illustrated, elements 104 are offset from elements 106 along electrical connector 108, with the first set of elements extending away from the connector in a first direction and the second set of elements extending away from the connector in a second, opposite direction, and in each unit 102, one more element 104 exists than the number of elements 106.

Unit 102, thus, electrically connects the cathode current collectors of all devices of panels A and B in parallel, electrically connects all anode current collectors of all devices of panels C and D in parallel, and electrically connects all of these together. It is noted that all cathodes of all panels, in the embodiment illustrated, are connected in parallel within each panel by virtue of “shared” current collectors 25. This adds to robustness in connection. A second unit 110 electrically interconnects all cathode current collectors of the devices of panels E and F in parallel and connects all of these to all of the anode current collectors of panels G and H.

A cathode collecting unit 112 electrically interconnects all of the cathode current collectors of panels G and H (the final two panels at one end of the stack) in parallel, and connects these to an external electrical circuit represented by unit 114. The anode current collectors of panels A and B (the final two panels at the opposite end of the stack) are joined in parallel by anode collecting unit 116, also electrically connected to an external circuit represented by unit 114. Cathode collecting unit 112 can be essentially identical to the cathode collecting portion of either of units 102 or 110, and anode collecting unit 116 similarly can be defined by the anode collecting portion of either of units 102 and 11. External circuit 114 can be a device powered by the stack, a storage device (e.g., battery), a power transmission line, any combination, or the like.

Unit 102 or 110, or both, can be constructed to span one panel in each direction, two panels in each direction (as illustrated), or any number of panels in each direction, each panel comprising one device, two devices, five devices, or any number of devices as described above. As such, the arrangement of FIG. 7 allows the electrical interconnection of any number of device anodes in parallel, any number of device cathodes in parallel, and the electrical interconnection of any number of parallel-connected device anodes in series with parallel-connected device cathodes, in series after series to any extent. In the arrangement illustrated in FIG. 7, all cathodes of the ten devices of panels A and B are connected in parallel and connected with all anodes of all ten devices of panels C and D. All cathodes of all ten devices of panels C and D are connected to all anodes of all ten devices of panels E and F. All cathodes of all ten devices of panels G and H are connected to the external circuit, as are all anodes of all devices of panels A and B.

The fork-like electrical connection units 102 and 110 find use in panels (not illustrated) similar to those of FIG. 46 but modified as follows. Modified panels can comprise essentially solid blocks of material through which are formed holes to allow passage of (and optionally support, current collectors, fuel delivery conduits, upwardly-extending portions of plugs 19, and electrochemical device bodies themselves) and also include conduits passing through the panels (perpendicular to the orientation of the current collectors as illustrated in FIG. 3), passing from panel to panel, across device to device. All conduits containing conductors defining units 102 and 110 can be bathed in a reductant gas, such as fuel, as in the embodiment illustrated in FIG. 3. In this arrangement, the conduits through which components of units 102 and 110 pass can define fuel delivery conduits or can be fluidly connected to fuel delivery conduits, under slight pressure sufficient to maintain the reductant gas environment around the conductors.

Referring now to FIG. 8, a side view of an interconnecting electric and/or fuel management system 120 according to another embodiment of the invention is illustrated. In FIG. 8 three electrochemical devices 40, 42, and 44 (illustrated very generally; can be similar to those illustrated in greater detail in FIG. 3) are illustrated schematically. Interconnecting unit 120 is an example of one embodiment of the invention in which the unit is an essentially solid block of material within which are formed or bored (during formation of the unit and/or after, via cutting, boring, etc.) a series of channels allowing electrical interconnection, delivery of fuel, and removal of exhaust. A series of indentations 122, 124, and 126, formed within unit 120, receive and, optionally, secure devices 40-44. For purposes of clarity, only one cathode current collector (25, 27, and 29, respectively) is illustrated for each device.

Interconnecting system 120 includes a plurality of passages 128, 130, and 132 for receiving cathode current collectors 25, 27, and 29, and a plurality of passages 134, 136, and 138 for receiving anode current collectors (not shown). Each of passages 128-138 extends upwardly into unit 120 to an approximately similar level. A plurality of holes, or passages, 140, 142, 144, 146, 148, and 150 pass laterally through the unit and intersect passages 134, 128, 136, 130, 138, and 132, respectively. Passages 140, 144, and 148 are constructed to receive electrically-conductive elements 106 (FIG. 7), and passages 142, 146, and 150 are constructed to receive electrical contact elements 104 (FIG. 7). In this way, current collectors residing in passages within unit 120 can be addressed by electrical contacts as illustrated in FIG. 7.

Unit 120 includes passages 152, 154, and 156 each extending upwardly from indentations 122, 124, and 126, respectively, and sized and shaped to receive, with reference to FIG. 3, upwardly extending portions of plug 19 and fuel delivery conduit 22.

Passages 158, 160, and 162 allow fluid communication between passages 140, 144, and 148 and the top portion of recesses 152, 154, and 156, respectively. In this manner, fuel can be delivered through conduits 140, 144, and 148, and communicated to fuel delivery conduits 22 when they are inserted within recesses 152, 154, and 156. Similar passages (not shown) can be provided to connect recesses 152, 154, and 156 to passages 142, 146, and 150, allowing fuel delivery through passages 142, 146, and 150 and bathing of conduits in those passages in fuel. This allows fuel delivery to each device via a conduit within which an electrical connector addressing a current collector of the system passes. Separate fuel delivery conduits also can be provided, in fluid communication with any passages containing electrically-conductive elements (leads) where the specific passages within which the electrical leads reside are not themselves fuel delivery conduits but are static flow passages connected to fuel delivery conduits so as to bathe electrical leads in the fuel or other reductant gas.

Exhaust conduits 164, 166, and 168 also pass laterally through unit 120, optionally arranged in parallel with passages 140-150, and are in fluid communication with recesses 152, 154, and 156. Although recesses and passages within unit 120 would seem to fluidly connect fuel delivery conduits with exhaust conduits, a fuel/exhaust barrier can be formed, in the embodiment illustrated, by sealing of an exterior surface of a fuel delivery conduit 22 (FIG. 3) inserted within its corresponding recess of unit 120 and the interior wall of that recess.

Upwardly-extending portions of plug 19 (FIG. 3) do not seal within corresponding recesses in unit 120, allowing fluid communication between exhaust conduits 164-168 and passage 17 (FIG. 3) formed between fuel delivery conduit 22 and plug 19. As noted above, where the exhaust is a reductant gas (e.g., by virtue of a reductant fuel not being fully consumed) electrical leads can be provided in fluid communication with exhaust conduits, in addition to or instead of fuel delivery conduits, to prevent electrical lead corrosion.

Various components of the invention can be fabricated by those of ordinary skill in the art from any of a variety of components. Components of the invention can be molded, machined, extruded, or formed by any other suitable technique, those of ordinary skill in the art are readily aware techniques for forming components of devices herein.

Fuel and/or oxidant conduits and manifold (interconnecting electric and/or fuel management systems defining panels and stacks, and interconnections therebetween) can be constructed of ceramic, stainless steel, other metals such as copper, or essentially any material that will not destructively interfere with the device or be easily corroded. These components typically are constructed of non-reactive materials, that is, materials that do not participate in any electrochemical reaction occurring in the device. The interior surfaces of conduits can be coated with an anti-coking agent, and/or a conduit can be constructed at least in part of an anti-coking agent, as described in international patent publication no. WO03/044887, referenced above. Of course, all components should be fabricated of material selected to operate effectively at the intended temperature (and temperature variation) to which the device will be exposed. Where a plug 19 is used, it typically is fabricated from a non-reactive material such as alumina.

An oxidation facilitator may be constructed of any material or materials that are able to be formed into the desired structure, and/or have the desired conductivity, and/or are sufficiently durable for use in the intended operating conditions of the electrochemical device. As noted above, the oxidation facilitator may or may not be ionically conductive, and may or may not be porous. The facilitator also may include a catalyst that lowers the activation energy for oxidation of fuel, and/or reforming of fuel and/or the well-known water-shift reaction.

In certain embodiments an oxidation facilitator may be constructed of ceramic materials. YSZ is one suitable composition for use in an oxidation facilitator in certain embodiments. “YSZ,” as used herein, refers to any yttria-stabilized zirconia material, for example, (ZrO₂)(HfO₂)_{0.02}(Y₂O₃)_{0.08}. For embodiments in which the fuel and anode are kept partially or completely physically separate from each other, it can be useful to use an ionically-conductive material and/or material able to conduct electrons. One example includes YSZ treated to allow it to conduct electrons, for example, YSZ doped with a metal such as tin, or another suitable dopant. In such a case, the oxidation facilitator typically is selected to be ionically conductive as well and, in such a case, a mixed ion/electron conductor can be selected. An example of a suitable mixed ion/electron conductor is YSZ/LCC, compounded in any of a variety of ratios selectable by those of ordinary skill in the art to achieve a desired balance of conduction. Other examples include doped cerium oxide, including CGO (gadolinium-doped cerium oxide), CYO (yttrium-doped cerium oxide), SDC (samarium-doped cerium oxide), YSZ doped with a metal such as nickel, or the like period. Typical dopant levels may be on the order of 10-20%, for example, CGO typically includes 10-20% gadolinium, and is a mixed conductor at temperature at and above about 600 degrees Celsius. CGO may also have the added benefit of acting as a catalyst for reduction of oxide species. Use of an oxidation facilitator that is a mixed ion/electron conductor can be advantageous in that it can effectively increase the interfacial area by re-ionizing oxygen and allowing it to be diffused into the mixed ion conductor. In such an embodiment, the interfacial area becomes the entire surface of the oxidation facilitator.

The oxidation facilitator also may include one or more catalysts to facilitate oxidation of fuel, reforming of fuel, and/or another purpose. Those of ordinary skill in the art are capable of selecting suitable catalysts for these purposes, and immobilizing them on a substrate defined by the oxidation facilitator. Examples include platinum, ruthenium, nickel, and doped or undoped cerium oxide.

Fuel may be delivered to an oxidation facilitator in any manner that provides sufficient fuel to the needed locations. The nature of the fuel delivery may vary with the type of fuel. For example, solid, liquid and gaseous fuels may all be introduced in different manners. A variety of fuel delivery options useful with liquid anodes are disclosed in international patent publication no. WO03/044887, referenced above. The fuel delivery techniques taught by this application may be modified to supply fuel to the oxidation facilitator, rather than directly to the anode. For example, in the embodiment illustrated in FIGS. 1 and 2, fuel delivery path 22 delivers fuel into fuel chamber 24. Fuel delivery paths could also enter the fuel chamber from other directions. For example, the fuel could be introduced into the bottom of the fuel chamber, via a delivery conduit passing through the bottom wall(s) of the device. The placement of the fuel delivery path may also vary with the arrangement of the oxidation facilitator and fuel chamber, if any. For example, the oxidation facilitator could be reversed compared to that shown on FIG. 1, such that the open side faces downward. In this case, the fuel delivery path may enter the fuel chamber from the bottom. The fuel delivery conduit can be made of alumina, in one embodiment.

Fuel may be delivered to an oxidation facilitator in such a manner as to inhibit clogging or coking. Potentially suitable strategies for reducing coking are disclosed in U.S. application Ser. No. 10/300,687 and International Application No. PCT/US02/37290. Fuel which is prone to coking may also be reformed prior to introduction into the electrochemical device. In addition, the use of an oxidation facilitator provides additional options for inhibiting coking, for example where a catalyst capable of reforming the fuel may be introduced into the oxidation facilitator, eliminating the need for external reformation.

Where coking is an issue, fuel may also be reformed by the anode. For example, where the anode is a liquid anode, the fuel may be introduced into the anode. Fuel that is not consumed to produce electricity in the anode may be reformed by the relatively high temperatures of the anode. The reformed fuel may then pass out of the anode via an oxidation facilitator, where more of it can react with the anode, increasing fuel efficiency of the electrochemical device. Fuel is reacted both within the anode and the oxidation facilitator. Other components of the invention including cathode, anode, electrolyte, current collectors, leads, conduits, etc., can be selected by those of ordinary skill in the art from readily available materials and in most cases the selection is not critical to the invention except with respect to uses described above. As an example, components can be selected as described in the following documents, each incorporated herein by reference: U.S. patent application Ser. Nos. 09/033,923; 09/837,864; 09/819,886; 10/300,687; International Patent Application Serial Nos. PCT/US03/03642; PCT/US02/37290; PCT/US02/20099; and PCT/US01/12616.

The anode, cathode, current collectors, electrolyte, circuitry, and other components can be selected by those of ordinary skill in the art from among known components, as well as those described in any of WO 01/80335, 2002/0015877, WO 03/001617, WO03/044887, PCT/US03/03642, or 60/391,626, referenced above. Specific examples follow, but the invention is not to be considered limited to these.

The anode can be a rechargeable anode, as taught in international patent publication no. WO 01/80335, referenced above, and can be selected from among metal or metal alloy anodes that are capable of existing in more than two oxidation states or in non-integral oxidation states. Certain metals can be oxidized to one or more oxidation states, any one of these states being of a sufficient electrochemical potential to oxidize the fuel. Conversely, if that metal is oxidized to its highest oxidation state, it may be reduced to more than one lower oxidation state (at least one having a higher oxidation state than neutral) where the anode is capable of functioning in any of these states. Alternatively, a metal oxide or mixed metal oxide may collectively oxidize fuel where metal ions are reduced by formal non-integer values.

Examples of anodic material that can be used to form the anode, or compounded with other materials to define an anode, include liquid anodes (that is, a material that is a liquid at operating temperatures of the device). In one embodiment, the device is operable, with the anode in a liquid state, at a temperature of less than about 1500° C., preferably at a temperature of less than about 1300° C., more preferably less than about 1200° C., even more preferably less than about 1000° C., and even more preferably less than about 800° C. By “operable”, it is meant that the device is able to generate electricity, either as an electrochemical device such as a fuel-to-energy conversion device or as a rechargeable device such as a battery and/or a chemical or fuel-rechargeable energy conversion unit with the anode in a liquid state, and the anode may not necessarily be a liquid at room temperature. It is understood by those of ordinary skill in the art that anodic temperature can be controlled by selection of anode materials or in the case of an alloy, composition and percentages of the respective metal components, i.e., composition can affect a melting point of the anode. Other exemplary operating temperature ranges include a temperature between about 300° C. to about 1500° C., between about 500° C. to about 1300° C., between about 500° C. to about 1200° C., between about 500° C. to about 1000° C., between about 600° C. to about 1000° C., between about 700° C. to about 1000° C., between about 800° C. to about 1000° C., between about 500° C. to about 900° C., between about 500° C. to about 800° C., and between about 600° C. to about 800° C.

The anode can be a pure liquid or can have solid and liquid components, so long as the anode as a whole exhibits liquid-like properties. Where the anode is a metal, it can be a pure metal or can comprise an alloy comprising two or more metals. In one set of embodiments, the anodic material is selected so as to have a standard reduction potential greater than −0.70 V versus the Standard Hydrogen Electrode (determined at room temperature). These values can be obtained from standard reference materials or measured by using methods known to those of ordinary skill in the art. The anode can be comprised of a transition metal, a main group metal, an alkaline metal, an alkaline earth metal, a lanthanide, an actinide and combinations thereof. Metals such as copper, molybdenum, mercury, iridium, palladium, antimony, rhenium, bismuth, platinum, silver, arsenic, rhodium, tellurium, selenium, osmium, gold, lead, germanium, tin, indium, thallium, cadmium, gadolinium, chromium nickel, iron, tungsten, cobalt, zinc, vanadium or combinations thereof can be useful. Examples of alloys include 5% lead with reminder antimony, 5% platinum with reminder antimony, 5% copper with reminder indium, 20% lead, 10% silver, 40% indium, 5% copper.

Although liquid anodes are more commonly used in the invention, solid anodes can be used as well, including metals such as main group metals, transition metals, lanthanides, actinides, ceramics (optionally doped with any metal listed herein) such as. Other suitable solid anodes are disclosed in references incorporated herein.

The cathode of the device typically is a solid-state cathode, e.g. a metal oxide or a mixed metal oxide. Specific examples include tin-doped In₂O₃, aluminum-doped zinc oxide and zirconium-doped zinc oxide. Another example of a solid state cathode is a perovskite-type oxide having a general structure of ABO₃, where “A” and “B” represent two cation sites in a cubic crystal lattice. A specific example of a perovskite-type oxide has a structure LaₓMn_{y}AₐB_{b}C_{c}O_{d} where A is an alkaline earth metal, B is selected from the group consisting of scandium, yttrium and a lanthanide metal, C is selected from the group consisting of titanium, vanadium, chromium, iron, cobalt, nickel, copper, zinc, zirconium, hafnium, aluminum and antimony, x is from 0 to about 1.05, y is from 0 to about 1, a is from 0 to about 0.5, b is from 0 to about 0.5, c is from 0 to about 0.5 and d is between about 1 and about 5, and at least one of x, y, a, b and c is greater than zero. More specific examples of perovskite-type oxides include LaMnO₃, La_{0.84}Sr_{0.16}MO₃, La_{0.84}Ca_{0.16}MnO₃, La_{0.84}Ba_{0.16}MnO₃, La_{0.65}Sr_{0.35}Mn_{0.8}Co_{0.2}O₃, La_{0.79}Sr_{0.16}Mn_{0.85}CO_{0.15}O₃, La_{0.84}Sr_{0.16}Mn_{0.8}Ni_{0.2}O₃, La_{0.84}Sr_{0.16}Mn_{0.8}Fe_{0.2}O₃, La_{0.84}Sr_{0.16}Mn_{0.8}Ce_{0.2}O₃, La_{0.84}Sr_{0.16}Mn_{0.8}Mg_{0.2}O₃, La_{0.84}Sr_{0.16}Mn_{0.8}Cr_{0.2}O₃, La_{0.6}Sr_{0.35}Mn_{0.8}Al_{0.2}O₃, La_{0.84}Sr_{0.16}MnO₃, La_{0.84}Y_{0.16}MnO₃, La_{0.7}Sr_{0.3}CoO₃, LaCoO₃, La_{0.7}Sr_{0.3}FeO₃, La_{0.5}Sr_{0.5}CO_{0.8}Fe_{0.2}O₃, or other LSM materials. As used herein, “LSM” refers to any lanthanum-strontium-manganese oxide, such as La_{0.84}Sr_{0.16}MnO₃. In other embodiments, the ceramic may also include other elements, such as titanium, tin, indium, aluminum, zirconium, iron, cobalt, manganese, strontium, calcium, magnesium, barium, or beryllium. Other examples of solid state cathodes include LaCoO₃, LaFeO₃, LaCrO₃, and a LaMnO₃-based perovskite oxide cathode, such as La_{0.75}Sr_{0.25}CrO₃, (La_{0.6}Sr_{0.4})_{0.9}CrO₃, La_{0.6}Sr_{0.4}FeO₃, La_{0.6}Sr_{0.4}CoO₃ or Ln_{0.6}Sr_{0.4}CoO₃, where Ln may be any one of La, Pr, Nd, Sm, or Gd. Alternatively, the cathode may comprise a metal, for example, the cathode may comprise a noble metal. Example metal cathodes include platinum, palladium, gold, silver, copper, rhodium, rhenium, iridium, osmium, and combinations thereof.

Current collectors should be selected to adequately deliver or remove electrical current to or from an electrode and, like other components, to operate effectively at typical device temperatures, and to be adequately resistant to conditions within the device that can cause chemical degradation to non-resistant materials. Examples include platinum as a cathode current collector, and graphite rod as an anode current collector. A wide variety of useful current collectors are described in international patent application no. PCT/US03/03642 and U.S. patent application no. 60/391,626, referenced above. In one arrangement, a current collector includes a sheathing material, a liquid metal (metal or alloy that is a liquid under typical operating conditions within an interior space of the sheathing material, and an electrical lead in contact with the liquid metal. Liquid metals can be selected from among, for example, copper, molybdenum, iridium, palladium, antimony, rhenium, bismuth, platinum, silver, arsenic, rhodium, tellurium, selenium, osmium, gold, lead, germanium, tin, indium, thallium, cadmium, chromium, nickel, iron, tungsten, cobalt, zinc, vanadium, gallium, aluminum, and alloys thereof. Examples of sheathing material include scandium, indium, a lanthanide, yttrium, titanium, tin, indium, aluminum, zirconium, iron, cobalt, manganese, strontium, calcium, magnesium, barium, beryllium, a lanthanide, chromium, and mixtures thereof. Combinations of the above compounds are also possible, such as alloys of any of the above metals, which may include combinations of the above metals or combinations with other metals as well. One example is a platinum-silver alloy having any suitable ratio, for example, 5% Pt:95% Ag, 10% Pt:90% Ag, 20% Pt:80% Ag, or the like. In some embodiments, the electrically conducting material and/or the sheathing material may be a heterogeneous material formed from a mix of materials. The mixture may be a mixture including any one of the materials previously described, for example, a ceramic mixture, a metal mixture, or a cermet mixture, where a “cermet” is a mixture of at least one metal compound and at least one ceramic compound, for example, as previously described. As one example, the cermet may include a material such as copper, silver, platinum, gold, nickel, iron, cobalt, tin, indium and a ceramic such as zirconium oxide, an aluminum oxide, an iron oxide, a nickel oxide, a lanthanum oxide, a calcium oxide, a chromium oxide, a silicate, a glass. Combinations of these materials are also contemplated. Additionally, other materials may be incorporated in the cermet, for example, graphite. Suitable cermet mixtures may include, for example, Cu/YSZ, NiO/NiFe₂O₄, NiO/Fe₂O₃/Cu, Ni/YSZ, Fe/YSZ, Ni/LCC, Cu/YSZ, NiAl₂O₃, or Cu/Al₂O₃. As used herein, “LCC” refers to any lanthanum-calcium-chromium oxide.

The electrolyte of the device should be selected to allow conduction of ions between the cathode and anode, typically the migration of oxygen ions. Solid state electrolytes can be used, and examples include metal oxides and mixed metal oxides. An example of a solid state electrolyte is an electrolyte having a formula (ZrO₂)(HfO₂)ₐ(TiO₂)_{b}(Al₂O₃)_{c}(Y₂O₃)_{d}(MₓO_{y})ₑ where a is from 0 to about 0.2, b is from 0 to about 0.5 c is from 0 to about 0.5, d is from 0 to about 0.5, x is greater than 0 and less than or equal to 2, y is greater than 0 and less than or equal to 3, e is from 0 to about 0.5, and M is selected from the group consisting of calcium, magnesium, manganese, iron, cobalt, nickel, copper, and zinc. More specifically, examples of solid state electrolytes include (ZrO₂), (ZrO₂)(Y₂O₃)_{0.08}, (ZrO₂)(HfO₂)_{0.02}(Y₂O₃)_{0.08}, (ZrO₂)(HfO₂)_{0.02}(Y₂O₃)_{0.5}, (ZrO₂)(HfO₂)_{0.02}(Y₂O₃)_{0.08}(TiO₂)_{0.10}, (ZrO₂)(HfO₂)_{0.02}(Y₂O₃)_{0.08}(Al₂O₃)_{0.10}, (ZrO₂)(Y₂O₃)_{0.08}(Fe₂O₃)_{0.05}, (ZrO₂)(Y₂O₃)_{0.08}(CoO)_{0.05}, (ZrO₂)(Y₂O₃)_{0.08}(ZnO)_{0.05}, (ZrO₂)(Y₂O₃)_{0.08}(NiO)_{0.05}, (ZrO₂)(Y₂O₃)_{0.08}(CuO)_{0.05}, (ZrO₂)(Y₂O₃)_{0.08}(MnO)_{0.05} and ZrO₂CaO. Other examples of solid state electrolytes include a YSZ, CeO₂-based perovskite, such as Ce_{0.9}Gd_{0.1}O₂ or Ce₁₋ₓGdₓO₂ where x is no more than about 0.5; lanthanum-doped ceria, such as (CeO)₁₋ₙ(LaO₅)ₙ where n is from about 0.01 to about 0.2; a LaGaO₃-based perovskite oxide, such as La₁₋ₓAₓGa_{1-y}B_{y}O₃ where A can be Sr or Ca, B can be Mg, Fe, Co and x is from about 0.1 to about 0.5 and y is from about 0.1 to about 0.5 (e.g. La_{0.9}Sr_{0.1}Ga_{0.8}Mg_{0.2}O₃); a PrGaO₃-based perovskite oxide electrolyte, such as Pr_{0.93}Sr_{0.07}Ga_{0.85}Mg_{0.15}O₃ or Pr_{0.93}Ca_{0.07}Ga_{0.85}Mg_{0.15}O₃; and a Ba₂In₂O₅-based perovskite oxide electrolyte, such as Ba₂(In₁₋ₓGaₓ)₂O₅ or (Ba₁₋ₓLaₓ)In₂O₅, where is x is from about 0.2 to about 0.5.

A wide variety of fuels can be used. Generally, the fuel will be gasified at at least one step of the process. Examples of classes of fuels include a carbonaceous material; sulfur; a sulfur-containing organic compound such as thiophene, thiourea and thiophenol; a nitrogen-containing organic compound such as nylon and a protein; ammonia, hydrogen and mixtures thereof. Typically, the fuel selected for the device is mission dependent. Examples of a fuel comprising a carbonaceous material include conductive carbon, graphite, quasi-graphite, coal, coke, charcoal, fullerene, buckminsterfullerene, carbon black, activated carbon, decolorizing carbon, a hydrocarbon, an oxygen-containing hydrocarbon, carbon monoxide, fats, oils, a wood product, a biomass and combinations thereof. Examples of a hydrocarbon fuel include saturated and unsaturated hydrocarbons, aliphatics, alicyclics, aromatics, and mixtures thereof. Other examples of hydrocarbons include gasoline, diesel, kerosene, methane, propane, butane, natural gas and mixtures thereof. Examples of oxygen-containing hydrocarbon fuels include alcohols which further include C₁-C₂₀ alcohols and combinations thereof. Specific examples include methanol, ethanol, propanol, butanol and mixtures thereof. However, almost all oxygen-containing hydrocarbon fuels capable of being oxidized by the anode materials disclosed herein may be used so long as the fuel is not explosive or does not present any danger at operating temperatures. Gaseous fuels such as hydrogen and SynGas (a mixture of hydrogen and carbon monoxide) may also be used in certain embodiments of the invention. In another aspect of the invention, the electrochemical device is capable of operating with more than one type of fuel. The vast majority of prior art fuel cells are designed to operate with a specific fuel type, usually hydrogen and less often methanol. This aspect of the invention makes it possible to capitalize on the benefits of different fuel types. For example, one type of fuel may provide a higher power output whereas another may provide a lower power output but affords lightweight properties. Enhanced performance may be achieved with one type of fuel, yet another type of fuel recharges the anode more efficiently. Other benefits for using different fuel types may be realized, for example, in situations where the price of one fuel type rises and economics dictate the use of a cheaper fuel. Environmental concerns may also be a deciding factor in changing the fuel type. Short term benefits may be realized, for example, in the situation where the supply of one fuel type is exhausted and only another fuel type is readily available.

The oxidant can be selected from species that will serve as oxidizing agent during operation, such as air, pure oxygen or an oxygen-containing gas, at atmospheric pressures or greater.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1-30. (canceled)

31. A system comprising:
a plurality of interconnected fuel-to-energy conversion devices, each device including a reactant gas chamber into which at least a first reactant gas is delivered via a conduit that isolates the first reactant gas from all other fluids by which the device operates, and an exterior; and
an external environment fluidly interconnecting the exterior of each device, within which each device is exposed to a second reactant gas.

32. A system as in claim 31, wherein the a plurality of interconnected fuel-to-energy conversion devices comprises a plurality of chemical or fuel-rechargeable energy conversion units.

33. A system as in claim 31, wherein the external environment is fluidly isolated from the reactant gas chamber of each device.

34. A system as in claim 31, wherein the first reactant gas is fuel and the second reactant gas is oxidant, or the first reactant gas is oxidant and the second reactant gas is fuel.

35. A system comprising at least one fuel-to-energy conversion device comprising a plurality of separately-manufactured components that are not isolated conduits, interconnected at inter-component junctions, at least one junction between non-conduit components defining a portion of an oxidant-fuel barrier.

36. A system as in claim 35, comprising at least one chemical or fuel-rechargeable energy conversion unit.

37. A system as in claim 35 wherein the junction includes adhesive.

38. A system as in claim 35, further comprising at least one isolated conduit.

39. A system as in claim 31, comprising:
a fuel-to-energy conversion device comprising a first end and a second end;
an anodic electrical lead addressing an anode of the device; and
a cathodic electrical lead addressing a cathode of the device;
wherein each of the anodic and cathodic electrical leads is routed to the first end of the device for connection to an external electrical circuit.

40. A system as in claim 39, wherein the fuel-to-energy conversion device is a chemical or fuel-rechargeable energy conversion unit.

41. A system as in claim 39, wherein the device is an elongated device having a longest dimension defined between the first end and the second end.

42. A system as in claim 39, comprising a plurality of the elongated fuel-to-energy conversion devices arranged in general alignment with each other, the first end of each device oriented generally in a similar direction, wherein the anodic and cathodic lead of each device is electrically connected to an anodic or cathodic lead of another device via circuitry at the first end of the device.

43. A system as in claim 42, each device comprising:
a reactant gas chamber including an inlet into which a reactant gas is introduced, an outlet from which an exhaust gas is expelled, and an exterior;
a first electrode surrounding at least a portion of the reactant gas chamber;
an electrolyte surrounding at least a portion of the first electrode; and
a second electrode surrounding at least a portion of the electrolyte, the system including an external environment fluidly interconnecting the exterior of each device, within which each device is exposed to a second reactant gas, wherein the reactant gas chamber contains either fuel or oxidant while the external environment contains oxidant or fuel, respectively, during normal device operation, wherein each of the electrical leads is in fluid communication with one of the fluid environments, but not the other.

44-45. (canceled)

46. A fuel-to-energy conversion device system comprising a plurality of interconnected, interoperative fuel-to-energy conversion devices each comprising an anode and a cathode; and
a direct electrically-conductive pathway interconnecting the cathodes of at least a two devices with the anodes of at least two, different devices.

47. A system as in claim 46, comprising a plurality of interconnected, interoperative chemical or fuel-rechargeable energy conversion units.

48. A system as in claim 31, further comprising an electrical connection apparatus for use in a fuel-to-energy conversion device system, comprising
a first set of a plurality of elongated, essentially rigid, electrically-conductive elements in fixed, essentially parallel relation to each other, constructed and arranged to electrically address a set of anodes of at least a first and a second fuel-to-energy conversion device;
a second set of a plurality of elongated, essentially rigid, electrically-conductive elements in fixed, essentially parallel relation to each other, constructed and arranged to electrically address a set of cathodes of at least a third and a fourth fuel-to-energy conversion device;
an electrical connector connecting the first set of elements with the second set of elements.

49. An electrical connection apparatus as in claim 48,
wherein the electrical connector supports the first set of elements and the second set of elements in fixed, essentially parallel relation to each other, with the first set of elements extending away from the connector in a first direction and the second set of elements extending away from the connector in a second direction opposite the first direction.

50. An electrical connection apparatus as in claim 48,
wherein the first set of elements comprises more elements than the second set of elements.

51. An electrical connection apparatus as in claim 48,
wherein the first set of elements comprises one more element than the second set of elements.

52-59. (canceled)
